(19) United States
(12) Patent Application Publication
(10) Pub. No.: US 2022/0289191 A1
(43) Pub. Date: Sep. 15, 2022

(54) VEHICLE CONTROL APPARATUS

(71) Applicant: Honda Motor Co., Ltd., Tokyo (JP)

(72) Inventor: Kazuki Yamoto, Wako-shi (JP)

(21) Appl. No.: 17/676,198

(22) Filed: Feb. 20, 2022

(30) Foreign Application Priority Data
Mar. 10, 2021 (JP) 2021-037939

(51) Int. Cl. B60W 30/16

(52) U.S. Cl. CPC B60W 30/16; B60W 2556/65; B60W 2754/30; B60W 2520/10; B60W 2554/4042; B60W 2540/215

(57) ABSTRACT

A vehicle control apparatus including a communication unit mounted on a subject vehicle so as to be communicably connected to a forward vehicle and a rearward vehicle, and an electronic control unit including a microprocessor. The microprocessor is configured to perform setting a first target inter-vehicle distance between the subject vehicle and the forward vehicle and a second target inter-vehicle distance between the subject vehicle and the rearward vehicle, transmitting information on the first and second target inter-vehicle distances to the forward vehicle and the rearward vehicle through the communication unit, and controlling a travel actuator so that a forward inter-vehicle distance between the subject vehicle and the forward vehicle is equal to or longer than the first target inter-vehicle distance and a rearward inter-vehicle distance between the subject vehicle and the rearward vehicle is equal to or longer than the second target inter-vehicle distance.

### CROSS-REFERENCE TO RELATED APPLICATION

This application is based upon and claims the benefit of priority from Japanese Patent Application No. 2021-037939 filed on Mar. 10, 2021, the content of which is incorporated herein by reference.

### BACKGROUND OF THE INVENTION

### Field of the Invention

This invention relates to a vehicle control apparatus.

### Description of the Related Art

Conventionally, there have been known apparatus configured to control an inter-vehicle distance between a subject vehicle and a forward vehicle. Such a device is described, for example, in Japanese Unexamined Patent Publication No. 10-338057 (JPH10-338057A). The apparatus described in JPH10-338057A is configured to set an inter-vehicle distance from a forward vehicle during following the forward vehicle according to a vehicle speed and a driver's preference.

However, the apparatus described in JPH10-338057A does not consider the mind of the driver to be followed, and may deteriorate the psychological state of the driver to be followed.

### SUMMARY OF THE INVENTION

An aspect of the present invention is a vehicle control apparatus including a communication unit mounted on a subject vehicle so that the subject vehicle is communicably connected to a forward vehicle traveling in front of a subject vehicle and a rearward vehicle traveling behind the subject vehicle, and an electronic control unit including a microprocessor and a memory connected to the microprocessor. The microprocessor is configured to perform setting a first target inter-vehicle distance between the subject vehicle and the forward vehicle and a second target inter-vehicle distance between the subject vehicle and the rearward vehicle, transmitting an information on the first target inter-vehicle distance and an information on the second target inter-vehicle distance to the forward vehicle and the rearward vehicle through the communication unit, respectively, and controlling an actuator for traveling so that a forward inter-vehicle distance between the subject vehicle and the forward vehicle is equal to or longer than the first target inter-vehicle distance and a rearward inter-vehicle distance between the subject vehicle and the rearward vehicle is equal to or longer than the second target inter-vehicle distance.

### BRIEF DESCRIPTION OF THE DRAWINGS

The objects, features, and advantages of the present invention will become clearer from the following description of embodiments in relation to the attached drawings, in which:

FIG. 1 is a diagram illustrating an overall configuration of a vehicle control system including a vehicle control apparatus according to an embodiment of the present invention;

FIG. 2 is a block diagram illustrating a configuration of a substantial part of the vehicle control apparatus according to the embodiment of the present invention;

FIG. 3 is a diagram for explaining an extra space set by the vehicle control apparatus according to the embodiment of the present invention;

FIG. 4A is a diagram illustrating an example of a forward target inter-vehicle distance set by the vehicle control apparatus according to the embodiment of the present invention;

FIG. 4B is a diagram illustrating another example of the forward target inter-vehicle distance set by the vehicle control apparatus according to the embodiment of the present invention;

FIG. 5 is a flowchart illustrating an example of a processing executed by a controller in FIG. 2; and

FIG. 6 is a diagram illustrating an example of a travel scene to which the vehicle control system according to the embodiment of the present invention is applied.

### DETAILED DESCRIPTION OF THE INVENTION

An embodiment of the present invention will be described below with reference to FIGS. 1 to 6. FIG. 1 is a diagram illustrating an example of a travel scene to which a vehicle control apparatus according to an embodiment of the present invention is applied, and is a diagram illustrating a vehicle control system 200 as a whole. As illustrated in FIG. 1, the vehicle control system 200 includes a plurality of (for example, three) vehicles 100 to 102 each including vehicle control apparatus 10. The configurations of the vehicle control apparatuses 10 of the vehicles 100 to 102 are the same as each other.

Hereinafter, among the three vehicles 100 to 102 traveling in the same direction, a vehicle located at the center will be referred to as a subject vehicle 100, and the configuration of the subject vehicle 100 will be mainly described. The vehicles 101 and 102 in front of and behind the subject vehicle 100 will be referred to as other vehicles to be distinguished from the subject vehicle 100. In particular, another vehicle traveling in the same direction as the subject vehicle 100 in front of the subject vehicle 100 will be referred to as forward vehicle 101, and another vehicle traveling in the same direction as the subject vehicle 100 behind the subject vehicle 100 will be referred to as rearward vehicle 102. The subject vehicle 100, the forward vehicle 101, and the rearward vehicle 102 are configured to be communicable with each other via communication units, that is, to be capable of inter-vehicle communication.

The subject vehicle 100 may be any of an engine vehicle having an internal combustion engine as a traveling drive source, an electric vehicle having a traveling motor as a traveling drive source, and a hybrid vehicle having an engine and a traveling motor as traveling drive sources. The subject vehicle 100 is a manual driving vehicle that travels by the driver's driving operation. The subject vehicle 100 may be a self-driving vehicle that does not require the driver's driving operation.

The vehicle control apparatus 10 according to the present embodiment is characterized in that target values of an inter-vehicle distance L1 (referred to as a forward inter-vehicle distance) between the subject vehicle 100 and the forward vehicle 101 and an inter-vehicle distance L2 (referred to as a rearward inter-vehicle distance) between the subject vehicle 100 and the rearward vehicle 102 are set by the vehicles 100 to 102 communicating via communication units.

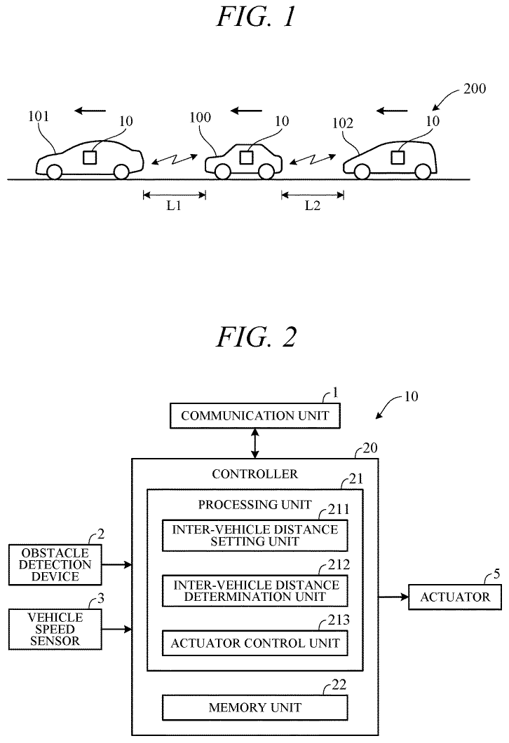

FIG. 2 is a block diagram illustrating a configuration of a substantial part of the vehicle control apparatus 10 according to the present embodiment. As illustrated in FIG. 2, the vehicle control apparatus 10 includes a communication unit 1, an obstacle detection device 2, a vehicle speed sensor 3, a controller 20, and an actuator 5. Hereinafter, the vehicle control apparatus of the subject vehicle 100 will be described.

The communication unit 1 is configured to perform inter-vehicle communication that is bidirectional communication. For example, the communication unit 1 is configured to perform inter-vehicle communication by intelligent transport system (ITS) communication, that is, narrow-area wireless communication using a dedicated frequency of an intelligent transport system. The communication unit 1 can also perform inter-vehicle communication using a mobile communication system such as 5G. The target values of the inter-vehicle distances L1 and L2 are transmitted to the other vehicles 101 and 102 via the communication unit 1, and the target values of the inter-vehicle distances L1 and L2 transmitted from the other vehicles 101 and 102 are received via the communication unit 1.

The obstacle detection device 2 includes sensors that can detect an obstacle around the subject vehicle 100 and measure a distance to the obstacle. Specifically, the obstacle detection device 2 includes a LIDAR (Light Detection And Ranging) that measures a distance from the subject vehicle 100 to an obstacle by measuring scattered light with respect to irradiation light in a predetermined direction of the subject vehicle 100, a RADAR (Radio Detection And Ranging) that detects an obstacle in the periphery of the subject vehicle 100 by irradiating the subject vehicle with an electromagnetic wave and detecting a reflected wave, and a camera that has an imaging element such as a CCD or a CMOS and captures images of the periphery of the subject vehicle 100. The obstacles include the forward vehicle 101 and the rearward vehicle 102. The obstacle detection device 2 is provided at a front portion and a rear portion of the subject vehicle 100, and measures the forward inter-vehicle distance L1 between the subject vehicle 100 and the forward vehicle 101 and the rearward inter-vehicle distance L2 between the subject vehicle 100 and the rearward vehicle 102.

The vehicle speed sensor 3 is a sensor that outputs a signal corresponding to the vehicle speed of the subject vehicle 100, and can detect the vehicle speed of the subject vehicle 100 by the vehicle speed sensor 3. The vehicle speed of the other vehicles 101 and 102 can also be detected based on changes in the inter-vehicle distances L1 and L2 detected by the obstacle detection device 2 and the vehicle speed of the subject vehicle 100 detected by the vehicle speed sensor 3. The vehicle speeds of the other vehicles 101 and 102 can be detected by acquiring, through the inter-vehicle communication, the vehicle speed information of the other vehicles 101 and 102 detected by their subject vehicle speed sensors 3.

The actuator 5 is a traveling actuator for controlling traveling of the subject vehicle 100. When the traveling drive source is an engine, the actuator 5 includes a throttle actuator that adjusts an opening of a throttle valve (throttle opening) of the engine. When the traveling drive source is a traveling motor, the traveling motor is included in the actuator 5. The actuator 5 also includes a brake actuator that operates the braking device of the subject vehicle and a steering actuator that drives the steering device of the subject vehicle.

The controller 20 includes a computer (an electronic control unit) having a processing unit 21 such as a microprocessor (CPU), the memory unit 22 such as a ROM and a RAM, and other peripheral circuits (not illustrated) such as an I/O interface. The processing unit 21 functions as an inter-vehicle distance setting unit 211, an inter-vehicle distance determination unit 212, and an actuator control unit 213. These units realize a mode of traveling with a desired inter-vehicle distance in front of and behind the subject vehicle 100, that is, a mode of traveling with an extra space (referred to as an extra space mode).

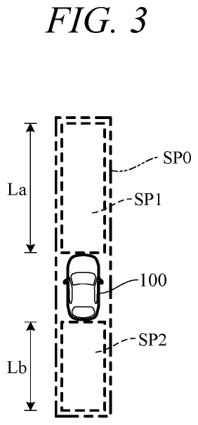

The memory unit 22 stores in advance characteristics of an extra space in front of and behind the subject vehicle 100. FIG. 3 is a plan view illustrating an extra space SP0. As illustrated in FIG. 3, the extra space SP0 includes a front extra space SP1 set in front of the subject vehicle 100 and a rear extra space SP2 set behind the subject vehicle. The front extra space SP1 has a length La corresponding to a target inter-vehicle distance (first target inter-vehicle distance) from the front end of the subject vehicle 100 to the rear end of the forward vehicle 101. The rear extra space SP2 has a length Lb corresponding to a target inter-vehicle distance (second target inter-vehicle distance) from the rear end of the subject vehicle 100 to the front end of the rearward vehicle 102. These extra spaces are memorized in a state of being classified into, for example, three spaces of a wide space, a middle space, and a narrow space. For the wide space, a value greater than that for the middle space is memorized, and for the narrow space, a value smaller than that for the middle space is memorized.

The memory unit 22 memorizes the wide space, the middle space, and the narrow space as characteristics of extra space in association with the vehicle speed. More specifically, the front extra space SP1 is memorized in association with the vehicle speed of the subject vehicle 100 (subject vehicle speed). That is, the narrow space (length La1) is memorized in association with the low subject vehicle speed, the middle space (length La2) is memorized in association with the medium subject vehicle speed, and the wide space (length La3) is memorized in association with the high subject vehicle speed. The lengths La1, La2, and La3 are in a relationship of La1<La2<La3. On the other hand, the rear extra space SP2 is memorized in association with the vehicle speed of the rearward vehicle 102 (rearward vehicle speed). That is, the narrow space (length Lb1) is memorized in association with the low rearward vehicle speed, the middle space (length Lb2) is memorized in association with the medium rearward vehicle speed, and the wide space (length Lb3) is memorized in association with the high rearward vehicle speed. The lengths Lb1, Lb2, and Lb3 are in a relationship of Lb1<Lb2<Lb3.

The inter-vehicle distance setting unit 211 sets the first target inter-vehicle distance La, which is a target value of the forward inter-vehicle distance L1 of the subject vehicle 100, and the second target inter-vehicle distance Lb, which is a target value of the rearward inter-vehicle distance L2 of the subject vehicle 100. Specifically, the inter-vehicle distance setting unit 211 specifies the length (any of La1, La2, and La3) corresponding to the subject vehicle speed detected by the vehicle speed sensor 3 based on characteristics (table and map) memorized in advance in the memory unit 22, and sets the length as the first target inter-vehicle distance La. The inter-vehicle distance setting unit 211 also calculates the rearward vehicle speed based on the subject vehicle speed detected by the vehicle speed sensor 3 and the change in the rearward inter-vehicle distance L2 detected by the obstacle detection device 2, specifies the length (any of Lb1, Lb2, and Lb3) corresponding to the rearward vehicle speed based on the characteristics (table and map) memorized in advance in the memory unit 22, and sets the length as the second target inter-vehicle distance Lb.

As the first target inter-vehicle distance La and the second target inter-vehicle distance Lb, respective three values (La1, La2, and La3) and (Lb1, Lb2, and Lb3) according to the vehicle speed may not be memorized in advance in the memory unit 22. Instead, characteristics of a target inter-vehicle distance that continuously changes according to the vehicle speed may be memorized, and the first target inter-vehicle distance La and the second target inter-vehicle distance Lb may be set using the characteristics. The subject vehicle speed and the rearward vehicle speed may be divided into a plurality of (for example, three) areas, characteristics of target inter-vehicle distances having different inclinations may be memorized in advance for each area, and the target inter-vehicle distances may be set using the characteristics. The first target inter-vehicle distance La and the second target inter-vehicle distance Lb are transmitted to the vehicle control apparatus 10 of the forward vehicle 101 and the vehicle control apparatus 10 of the rearward vehicle 102 via the communication unit 1.

The target inter-vehicle distances La and Lb may be set according to the driver's preferences. For example, a switch for setting an extra space may be provided, and the driver may select one of wide space (first space), middle space (second space), and narrow space (third space) for the front extra space SP1 by a switch operation, select one of wide space, middle space, and narrow space for the rear extra space SP2, and set the target inter-vehicle distance according to the selection. The number of selective candidates for the target inter-vehicle distances may not be three but may be two or four or more.

The inter-vehicle distance determination unit 212 receives, from the forward vehicle 101 via the communication unit 1, information on the target inter-vehicle distance set by the forward vehicle 101, that is, information on the target inter-vehicle distance (referred to as third target inter-vehicle distance Lc) between the subject vehicle 100 and the forward vehicle 101. The inter-vehicle distance determination unit 212 then determines a forward target inter-vehicle distance Lf based on the first target inter-vehicle distance La set by the inter-vehicle distance setting unit 211 and the received third target inter-vehicle distance Lc.

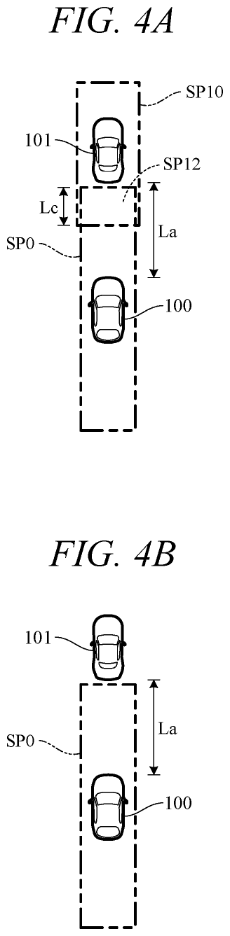

FIG. 4A is a diagram illustrating an example of the forward target inter-vehicle distance Lf. As illustrated in FIG. 4A, an extra space SP10 is set around the forward vehicle 101. The extra space SP 10 includes a rear extra space SP 12, and the third target inter-vehicle distance Lc corresponding to the rear extra space SP 12 is set. The inter-vehicle distance determination unit 212 determines the longer one of the first target inter-vehicle distance La and the third target inter-vehicle distance Lc (La in the example of FIG. 4A) as the forward target inter-vehicle distance Lf.

FIG. 4B is a diagram illustrating another example of the forward target inter-vehicle distance Lf In FIG. 4B, the forward vehicle 101 has not set the third target inter-vehicle distance Lc, so that the third target inter-vehicle distance Lc is 0. In this case, the first target inter-vehicle distance La becomes the forward target inter-vehicle distance Lf. Also if the forward vehicle 101 does not have inter-vehicle communication, the third target inter-vehicle distance Lc is 0.

The inter-vehicle distance determination unit 212 further receives, from the rearward vehicle 102 via the communication unit 1, information on the target inter-vehicle distance set by the rearward vehicle 102, that is, information on the target inter-vehicle distance (referred to as fourth target inter-vehicle distance Ld) between the subject vehicle 100 and the rearward vehicle 102. The inter-vehicle distance determination unit 212 then determines a rearward target inter-vehicle distance Lr based on the second target inter-vehicle distance Lb set by the inter-vehicle distance setting unit 211 and the received fourth target inter-vehicle distance Ld. Specifically, as in the case of determining the forward target inter-vehicle distance Lf, the inter-vehicle distance determination unit 212 determines the longer one of the second target inter-vehicle distance Lb and the fourth target inter-vehicle distance Ld as the rearward target inter-vehicle distance Lr. The information on the determined target inter-vehicle distances Lf and Lr may be transmitted to the other vehicles 101 and 102 via the communication unit 1.

The actuator control unit 213 controls the actuator 5 by outputting a control signal to the actuator 5 so that the forward inter-vehicle distance L1 (FIG. 1) between the subject vehicle 100 and the forward vehicle 101 becomes equal to or longer than the forward target inter-vehicle distance Lf determined by the inter-vehicle distance determination unit 212. The actuator control unit 213 also controls the actuator 5 by outputting a control signal to the actuator 5 so that the rearward inter-vehicle distance L2 (FIG. 1) between the subject vehicle 100 and the rearward vehicle 102 becomes equal to or longer than the rearward target inter-vehicle distance Lr determined by the inter-vehicle distance determination unit 212. The actuator control units 213 of the forward vehicle 101 and rearward vehicle 102 similarly control the respective actuators 5 of the vehicles 101 and 102.

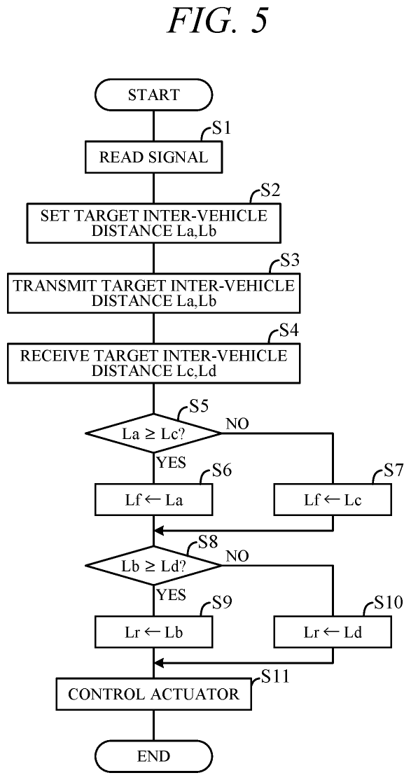

FIG. 5 is a flowchart illustrating an example of processing executed by the controller 20 of FIG. 2. The processing illustrated in this flowchart is started when a switch for ordering an extra-space command mode is provided and the extra-space mode is ordered by the driver's switch operation, and is repeated at a predetermined cycle.

First, in S1 (S: processing step), the controller 20 reads signals from the obstacle detection device 2 and the vehicle speed sensor 3. Then, in S2, as illustrated in FIG. 3, the controller 20 sets the first target inter-vehicle distance La and the second target inter-vehicle distance Lb in front of and behind the subject vehicle 100. That is, the controller 20 sets the first target inter-vehicle distance La corresponding to the subject vehicle speed detected by the vehicle speed sensor 3, and calculates the vehicle speed (rearward vehicle speed) of the rearward vehicle 102 by the vehicle speed sensor 3 and the obstacle detection device 2, and sets the second target inter-vehicle distance Lb corresponding to the rearward vehicle speed. The rearward vehicle speed may be acquired by inter-vehicle communication to set the second target inter-vehicle distance Lb.

Then, in S3, the controller 20 transmits information on the first target inter-vehicle distance La and the second target inter-vehicle distance Lb to the vehicle control apparatuses 10 of the forward vehicle 101 and the rearward vehicle 102, respectively, via the communication unit 1. Then, in S4, the controller 20 performs inter-vehicle communication with the forward vehicle 101 and the rearward vehicle 102 via the communication unit 1, thereby to receive information on the third target inter-vehicle distance Lc (FIG. 4A) set by the forward vehicle 101 and the fourth target inter-vehicle distance Ld set by the rearward vehicle 102. When the information on the third target inter-vehicle distance Lc and the fourth target inter-vehicle distance Ld cannot be received, for example, when the forward vehicle 101 and the rearward vehicle 102 have not set the target inter-vehicle distances Lc and Ld, the controller 20 sets these distances to 0.

Then, in S5, the controller 20 determines whether the first target inter-vehicle distance La set in S2 is equal to or longer than the third target inter-vehicle distance Lc received in S4. When the determination is in the affirmative in S5, the processing proceeds to S6, and the controller 20 determines the first target inter-vehicle distance La as the forward target inter-vehicle distance Lf. On the other hand, when the determination is in the negative in S5, the processing proceeds to S7, and the controller 20 determines the third target inter-vehicle distance Lc as the forward target inter-vehicle distance Lf.

Then, in S8, the controller 20 determines whether the second target inter-vehicle distance Lb set in S2 is equal to or longer than the fourth target inter-vehicle distance Ld received in S4. When the determination is in the affirmative in S8, the processing proceeds to S9, and the controller 20 determines the second target inter-vehicle distance Lb as the rearward target inter-vehicle distance Lr. On the other hand, when the determination is in the negative in S8, the processing proceeds to S10, and the controller 20 determines the fourth target inter-vehicle distance Ld as the rearward target inter-vehicle distance Lr.

Then, in S11, the controller 20 controls the actuator 5 such that the forward inter-vehicle distance L1 becomes equal to or longer than the forward target inter-vehicle distance Lf. The controller 20 further controls the actuator 5 such that the rearward inter-vehicle distance L2 becomes equal to or longer than the rearward target inter-vehicle distance Lr, and terminates the process. The above processing is also performed in the vehicle control apparatus 10 of the forward vehicle 101 and in the vehicle control apparatus 10 of the rearward vehicle 102. In this case, the first target inter-vehicle distance La transmitted from the subject vehicle 100 is the fourth target inter-vehicle distance Ld for the forward vehicle 101, and the second target inter-vehicle distance Lb is the third target inter-vehicle distance Lc for the rearward vehicle 102.

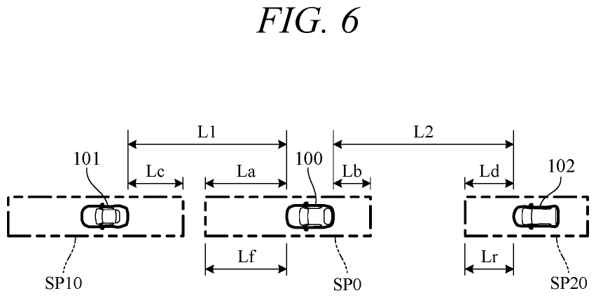

The operation of the vehicle control system 200 according to the present embodiment will be described more specifically. FIG. 6 is an example of a travel scene to which the vehicle control system 200 according to the present embodiment is applied. As illustrated in FIG. 6, the extra space SP0 is set around the subject vehicle 100, and extra spaces SP10 and SP20 are also set around the forward vehicle 101 and the rearward vehicle 102, respectively. In comparison between the first target inter-vehicle distance La in front of the subject vehicle 100 and the third target inter-vehicle distance Lc behind the forward vehicle 101, the first target inter-vehicle distance La is longer. Therefore, the first target inter-vehicle distance La is set as the forward target inter-vehicle distance Lf (S6). On the other hand, in comparison between the second target inter-vehicle distance Lb behind the subject vehicle 100 and the fourth target inter-vehicle distance Ld in front of the rearward vehicle 102, the fourth target inter-vehicle distance Ld is longer. Therefore, the fourth target inter-vehicle distance Ld is set as the rearward target inter-vehicle distance Lr (S10).

Therefore, the inter-vehicle distance (forward inter-vehicle distance L1) between the subject vehicle 100 and the forward vehicle 101 is equal to or longer than the forward target inter-vehicle distance Lf, and the inter-vehicle distance (rearward inter-vehicle distance L2) between the subject vehicle 100 and the rearward vehicle 102 is equal to or longer than the rearward target inter-vehicle distance Lr (S11). More specifically, if the driver of the subject vehicle 100 accelerates to shorten the forward inter-vehicle distance L1 and the forward inter-vehicle distance L1 reaches the forward target inter-vehicle distance Lf, the acceleration of the subject vehicle 100 is suppressed, and the forward inter-vehicle distance L1 is controlled to the forward target inter-vehicle distance Lf In addition, if the driver of the rearward vehicle 102 accelerates to shorten the rearward inter-vehicle distance L2 and the rearward inter-vehicle distance L2 reaches the rearward target inter-vehicle distance Lr, the acceleration of the rearward vehicle 102 is suppressed and the rearward inter-vehicle distance L2 is controlled to the rearward target inter-vehicle distance Lr. This makes it possible to maintain the forward and rearward inter-vehicle distances L1 and L2 at desired inter-vehicle distances or more for the driver, and to suppress deterioration of the driver's psychological state due to shortening of the inter-vehicle distances L1 and L2.

The present embodiment can achieve advantageous effects as follows:

(1) The vehicle control apparatus 10 includes: the inter-vehicle distance setting unit 211 that sets the first target inter-vehicle distance La between the subject vehicle 100 and the forward vehicle 101 traveling in front of the subject vehicle 100 and the second target inter-vehicle distance Lb between the subject vehicle 100 and the rearward vehicle 102 traveling behind the subject vehicle 100; the communication unit 1 that is mounted on the subject vehicle 100 so that the subject vehicle 100 is communicably connected to the forward vehicle 101 and the rearward vehicle 102 and transmits information on the first target inter-vehicle distance La and the second target inter-vehicle distance Lb set by the inter-vehicle distance setting unit 211 to the forward vehicle 101 and the rearward vehicle 102, respectively; and the actuator control unit 213 that controls the actuator 5 for vehicle traveling such that the forward inter-vehicle distance L1 to the forward vehicle 101 is equal to or longer than the first target inter-vehicle distance La and the rearward inter-vehicle distance L2 to the rearward vehicle 102 is equal to or longer than the second target inter-vehicle distance Lb (FIG. 2).

As a result, the inter-vehicle distances in front of and behind the subject vehicle 100 become desired values or more, thereby making it possible to suppress deterioration of the driver's psychological state due to shortening of the inter-vehicle distances. In particular, when the rearward inter-vehicle distance L2 becomes shorter, the psychological burden on the driver increases. However, since the information on the second target inter-vehicle distance Lb is transmitted to the rearward vehicle 102, when the rearward inter-vehicle distance L2 reaches the second target inter-vehicle distance Lb, the acceleration of the rearward vehicle 102 is suppressed by the control of the vehicle control apparatus 10 of the rearward vehicle 102, so that the desired target inter-vehicle distance can be maintained.

(2) The communication unit 1 is further configured to receive information on the third target inter-vehicle distance Lc (forward target inter-vehicle distance), which is the target inter-vehicle distance between the forward vehicle 101 and the subject vehicle 100, set by the forward vehicle 101 and transmitted from the forward vehicle 101 (FIG. 5). The actuator control unit 213 controls the actuator 5 such that the forward inter-vehicle distance L1 becomes a value corresponding to the first target inter-vehicle distance La and the third target inter-vehicle distance Lc (FIG. 5). This makes it possible to set the forward target inter-vehicle distance Lf in consideration of not only the setting on the subject vehicle 100 but also the setting on the forward vehicle 101.

(3) The communication unit 1 is further configured to receive information on the fourth target inter-vehicle distance Ld (rearward target inter-vehicle distance), which is the target inter-vehicle distance between the rearward vehicle 102 and the subject vehicle 100, set by the rearward vehicle 102 and transmitted from the rearward vehicle 102 (FIG. 5). The actuator control unit 213 controls the actuator 5 such that the rearward inter-vehicle distance L2 becomes a value corresponding to the second target inter-vehicle distance Lb and the fourth target inter-vehicle distance Ld (FIG. 5). This makes it possible to set the rearward target inter-vehicle distance Lr in consideration of not only the setting on the subject vehicle 100 but also the setting on the rearward vehicle 102.

(4) The actuator control unit 213 controls the actuator 5 such that the forward inter-vehicle distance L1 becomes a value equal to or greater than a larger value of the first target inter-vehicle distance La and the third target inter-vehicle distance Lc (FIG. 5). As a result, the forward target inter-vehicle distance Lf can be controlled to an optimum value reflecting the settings on the subject vehicle 100 and the forward vehicle 101.

(5) The actuator control unit 213 controls the actuator 5 such that the rearward inter-vehicle distance L2 becomes a value equal to or greater than a larger value of the second target inter-vehicle distance Lb and the fourth target inter-vehicle distance Ld (FIG. 5). As a result, the rearward target inter-vehicle distance Lr can be controlled to an optimum value reflecting the settings on the subject vehicle 100 and the rearward vehicle 102.

In the above embodiment, the obstacle detection device 2 detects the forward inter-vehicle distance L1 between the subject vehicle 100 and the forward vehicle 101 and the rearward inter-vehicle distance L2 between the subject vehicle 100 and the rearward vehicle 102. However, when the vehicles 100 to 102 each have position detection devices such as position measurement sensors (for example, a GPS sensors), the positions of the vehicles 100 to 102 can be detected by the position detection devices. The vehicle speeds can also be detected by calculating the amounts of changes in the detected positions per unit time. In this case, the position information and vehicle speed information of the vehicles may be acquired via inter-vehicle communication. Therefore, the obstacle detection devices 2 can be omitted.

The present invention includes a first vehicle, a second vehicle behind the first vehicle, and a third vehicle behind the second vehicle, which can be used as the vehicle control system 200 including the same vehicle control apparatuses 10. In this case, when the first vehicle is the subject vehicle, the second vehicle is the rearward vehicle, when the second vehicle is the subject vehicle, the first vehicle is the forward vehicle the third vehicle is the rearward vehicle, and when the third vehicle is the subject vehicle, the second vehicle is the forward vehicle.

The present invention can be also used as a vehicle control method including: setting a first target inter-vehicle distance La between a subject vehicle 100 and a forward vehicle 101 traveling in front of the subject vehicle 100 and a second target inter-vehicle distance Lb between the subject vehicle 100 and a rearward vehicle 102 traveling behind the subject vehicle 100; transmitting an information on the first target inter-vehicle distance La and an information on the second target inter-vehicle distance Lb to the forward vehicle 101 and the rearward vehicle 102, through a communication unit 1 mounted on the subject vehicle 100 so that the subject vehicle 100 is communicably connected to the forward vehicle 101 and the rearward vehicle 102, respectively; and controlling an actuator 5 for traveling so that a forward inter-vehicle distance L1 between the subject vehicle 100 and the forward vehicle 101 is equal to or longer than the first target inter-vehicle distance La and a rearward inter-vehicle distance L2 between the subject vehicle 100 and the rearward vehicle 102 is equal to or longer than the second target inter-vehicle distance Lb.

The above embodiment can be combined as desired with one or more of the above modifications. The modifications can also be combined with one another.

According to the present invention, it is possible to control a vehicle travel operation with inter-vehicle distances spaced between a forward vehicle and a subject vehicle and between a rearward vehicle and the subject vehicle so as not to deteriorate a driver's psychological state.

Above, while the present invention has been described with reference to the preferred embodiments thereof, it will be understood, by those skilled in the art, that various changes and modifications may be made thereto without departing from the scope of the appended claims.

What is claimed is:

1. A vehicle control apparatus comprising:
a communication unit mounted on a subject vehicle so that the subject vehicle is communicably connected to a forward vehicle traveling in front of the subject vehicle and a rearward vehicle traveling behind the subject vehicle; and
an electronic control unit including a microprocessor and a memory connected to the microprocessor, wherein
the microprocessor is configured to perform
setting a first target inter-vehicle distance between the subject vehicle and the forward vehicle and a second target inter-vehicle distance between the subject vehicle and the rearward vehicle;
transmitting an information on the first target inter-vehicle distance and an information on the second target inter-vehicle distance to the forward vehicle and the rearward vehicle through the communication unit, respectively; and
controlling an actuator for traveling so that a forward inter-vehicle distance between the subject vehicle and the forward vehicle is equal to or longer than the first target inter-vehicle distance and a rearward inter-vehicle distance between the subject vehicle and the rearward vehicle is equal to or longer than the second target inter-vehicle distance.

2. The vehicle control apparatus according to claim 1, wherein
the microprocessor is configured to further perform
receiving an information on a forward target inter-vehicle distance set by the forward vehicle and transmitted from the forward vehicle, through the communication unit, the forward target inter-vehicle distance being a target inter-vehicle distance between the forward vehicle and the subject vehicle, and
the microprocessor is configured to perform
the controlling including controlling the actuator such that the forward inter-vehicle distance becomes a value corresponding to the first target inter-vehicle distance and the forward target inter-vehicle distance.

3. The vehicle control apparatus according to claim 1, wherein
the microprocessor is configured to further perform
receiving an information on a rearward target inter-vehicle distance set by the rearward vehicle and transmitted from the rearward vehicle, through the communication unit, the rearward target inter-vehicle distance being a target inter-vehicle distance between the rearward vehicle and the subject vehicle, and
the microprocessor is configured to perform
the controlling including controlling the actuator such that the rearward inter-vehicle distance becomes a value corresponding to the second target inter-vehicle distance and the rearward target inter-vehicle distance.

4. The vehicle control apparatus according to claim 2, wherein
the microprocessor is configured to perform
the controlling including controlling the actuator so that the forward inter-vehicle distance is equal to or greater than a larger value of the first target inter-vehicle distance and the forward target inter-vehicle distance.

5. The vehicle control apparatus according to claim 3, wherein
the microprocessor is configured to perform
the controlling including controlling the actuator so that the rearward inter-vehicle distance is equal to or greater than a larger value of the second target inter-vehicle distance and the rearward target inter-vehicle distance.

6. The vehicle control apparatus according to claim 1, further comprising:
a first vehicle speed detection device that detects a vehicle speed of the subject vehicle; and
a second vehicle speed detection device that detects a vehicle speed of the rearward vehicle, wherein
the microprocessor is configured to perform
the setting including setting the first target inter-vehicle distance in accordance with the vehicle speed of the subject vehicle detected by the first vehicle speed detection device, and the second target inter-vehicle distance in accordance with the vehicle speed of the rearward vehicle detected by the second vehicle speed detection device.

7. The vehicle control apparatus according to claim 1, wherein
the microprocessor is configured to perform
the setting including setting at least one of the first target inter-vehicle distance and the second target inter-vehicle distance to any of a first space, a second space narrower than the first space, and a third space narrower than the second space, in accordance with an operation of a switch by a driver.

8. A vehicle control system comprising a subject vehicle, a forward vehicle traveling in front of the subject vehicle, and a rearward vehicle behind the subject vehicle, wherein
each of the subject vehicle, the forward vehicle and the rearward vehicle includes:
a communication unit provided so as to be communicably between the subject vehicle and the forward vehicle and between the subject vehicle and the rearward vehicle; and
an electronic control unit including a microprocessor and a memory connected to the microprocessor, wherein
the microprocessor of the subject vehicle is configured to perform
setting a first target inter-vehicle distance between the subject vehicle and the forward vehicle and a second target inter-vehicle distance between the subject vehicle and the rearward vehicle;
transmitting an information on the first target inter-vehicle distance and an information on the second target inter-vehicle distance to the forward vehicle and the rearward vehicle through the communication unit, respectively; and
controlling an actuator for traveling such that a forward inter-vehicle distance between the subject vehicle and the forward vehicle is equal to or longer than the first target inter-vehicle distance and a rearward inter-vehicle distance between the subject vehicle and the rearward vehicle is equal to or longer than the second target inter-vehicle distance.

9. A vehicle control method comprising:
setting a first target inter-vehicle distance between a subject vehicle and a forward vehicle traveling in front of the subject vehicle and a second target inter-vehicle distance between the subject vehicle and a rearward vehicle traveling behind the subject vehicle;
transmitting an information on the first target inter-vehicle distance and an information on the second target inter-vehicle distance to the forward vehicle and the rearward vehicle, through a communication unit mounted on the subject vehicle so that the subject vehicle is communicably connected to the forward vehicle and the rearward vehicle, respectively; and
controlling an actuator for traveling so that a forward inter-vehicle distance between the subject vehicle and the forward vehicle is equal to or longer than the first target inter-vehicle distance and a rearward inter-vehicle distance between the subject vehicle and the rearward vehicle is equal to or longer than the second target inter-vehicle distance.
